(19) United States
(12) Patent Application Publication
(10) Pub. No.: US 2008/0162948 A1
(43) Pub. Date: Jul. 3, 2008

(54) Digital Information Storage System, Digital Information Security System, Method for Storing Digital Information and Method for Service Digital Information

(75) Inventors: Jong-Uk Choi, Seoul (KR); Gang-Yong Bae, Seoul (KR)

Correspondence Address: DITTHAVONG MORI & STEINER, P.C., 918 Prince St., Alexandria, VA, 22314, US

(73) Assignee: Markany Inc., Seoul (KR)

(21) Appl. No.: 11/814,777

(22) PCT Filed: May 22, 2006
(86) PCT No.: PCT/KR06/01914

§ 371 Date: Jul. 25, 2007

(30) Foreign Application Priority Data
Nov. 16, 2005 (KR) 10-2005-0109671
Mar. 28, 2006 (KR) 10-2006-0027813

(51) Int. Cl. G06F 12/14

(52) U.S. Cl. 713/193

(57) ABSTRACT

Provided is a digital information storage system, a digital information security system, and a digital information storing method, and a digital information providing method, and more particularly, to a digital information storage system including: a shared storage containing unique hardware information; and one or more user terminals interoperating with the shared storage through a network, encrypting digital information by using the hardware information of the shared storage and storing the encrypted digital information in the shared storage, and decoding the encrypted digital information by using the hardware information while loading the stored digital information. Accordingly, digital information is encrypted by using hardware information of a shared storage. The digital information can be thus protected from leakage caused by an illegal copy or the like. In addition, the shared storage for storing the digital information is connected to a user terminal in the form of a network drive, thereby improving convenience in use. Various functions (e.g. editing, printing, etc) can be further provided on the basis of ACL information.

### TECHNICAL FIELD

The present invention relates to a digital information storage system, a digital information security system, a method for storing digital information, and a method for service digital information, and more particularly, to a digital information storage system, a digital information security system, and a digital information storing method, and a digital information providing method, each of which uses hardware information of a shared storage to perform encryption and decoding operations, thereby achieving enhanced security and convenience in use.

### BACKGROUND ART

Recently, with the popularization of the high speed data communication service, and the computerized work environment, it has been possible to share digital information through a network. The digital information is defined as an archive (e.g. text, image, etc) that can be created in a specific file format by an application program.

The digital information may be basically shared when a terminal simply interoperates with another terminal through a LAN (Local Area Network). In general, a digital information management system such as a KMS (Knowledge Management System) or an EDMS (Electronic Document Management System) is used in work places requiring a systematic information management solution, for example, enterprises, government and public offices, monetary facilities, medical institutions, and state of the art research institutes.

The digital information management system enables users to share information, thereby improving work efficiency. In addition, various advantages are provided, for example, information backup ensuring a stable work, and improved convenience in management.

In spite of such advantages, the digital information management system is vulnerable to critical information leakage. Since most of digital information to be shared and stored in a database is stored in atypical format, in practice, the stored digital information is publicly and illegally distributed by users internally and externally.

In particular, the digital information shared by the digital information management system includes not only general materials, of which content can be shared, but also a large number of materials that are externally and internally confidential. When these materials are exposed by mistake of by intention of insiders, it may cause severe damage to a company.

Therefore, digital information security techniques are currently being developed to avoid illegal distribution and use thereof. Examples of a typical digital information security technique include a firewall install technique, an e-mail user restriction technique, and a DRM (Digital Right Management, hereinafter referred to as DRM) technique.

The firewall install technique is defined as a technique for avoiding an illegal external access to the digital information. In general, the firewall install technique is used for system security, network security, and so on. However, this technique is suitable for a defense against external attacks rather than for a management of users working for an enterprise or organization. Thus, the technique is difficult to be applied when information leakage occurs by an internal user.

The e-mail user restriction technique is defined as a technique for avoiding leakage of digital information by restricting volume of files attached in e-mails or by controlling traffic conforming to TCP/IP (Transmission Control Protocol/Internet Protocol). This technique also has a drawback in that digital information cannot be protected against information leakage when using a communication route except for a currently managed network, or using a diskette, an external storage device, and so on.

Meanwhile, the DRM technique is defined as a technique which prevents illegal distribution and copy of multimedia information, manages users so that only legitimate users can use information, and manages copyright of the multimedia information through a billing service such as payment. The DRM technique is based on encryption, and thus is being accepted as the most feasible solution capable of managing copyright of digital information.

Therefore, many current digital information security systems are based on the DRM technique.

In general, a conventional digital information security system based on the DRM technique includes a shared storage medium for storing digital information transmitted from a plurality of user terminals. The shared storage medium is managed by a security server. That is, the shared storage medium is managed by an OS (Operating System).

The security server registers and manages a user key provided for individual users. Digital information delivered from respective user terminals is encrypted according to a specific encryption algorithm, and is then stored in the shared storage medium. Further, when a request to access the stored digital information is received from a specific user terminal, pre-registered user key information is used to generate encrypted digital information to be read by only the specific user terminal, thereby transmitting it to a relevant user. Accordingly, users can read the digital information stored in the shared storage medium through their own terminals.

### DISCLOSURE OF INVENTION

### Technical Problem

However, the conventional digital information security system has several disadvantages as follows.

First, as mentioned above, the conventional digital information security system requires one or more service servers (e.g. security server) for managing the shared storage medium. For example, ACL (Access Control logic, hereinafter referred to as ACL) information of each user terminal, user key information, and encryption information are all managed by operating systems of the security servers. This causes high cost for system implementation. Moreover, a system structure and a session process become further complex.

Second, the convention digital information security system is performed by using only a user key or a random key which has undergone encryption of digital information. Thus, a problem still lies in that the digital information is likely to be leaked due to an illegal copy or the like.

Third, the convention digital information security system requires a separate application program (e.g. a dedicated viewer) to allow a user to access the digital information stored in the shared storage medium. In general, however, only simple reading is allowed for the provided digital information, resulting in inconvenience in use.

Accordingly, there is a demand for a technique related to digital information security whereby a system with a simple structure, providing convenience in use, and having an excellent security function can be implemented.

### Technical Solution

In order to solve the above-mentioned problems, according to a first aspect of the invention, there is provided a digital information storage system that provides an excellent security and convenience in use without having to use a separate security server.

According to a second aspect of the present invention, there is provided a digital information storage system that can be used in the digital information storage system.

According to a third aspect of the present invention, there is provided a method of storing digital information capable of encrypting digital information on the basis of hardware information of a shared storage, and storing the encrypted digital information.

According to a fourth aspect of the present invention, there is provided a method of providing digital information capable of providing digital information encrypted on the basis of user ACL information.

### Advantageous Effects

According to the present invention, digital information is encrypted by using hardware information of a shared storage. The digital information can be thus protected against leakage caused by an illegal copy or the like. In addition, the shared storage for storing the digital information is connected to a user terminal in the form of a network drive, thereby improving convenience in use. Various functions (e.g. editing, printing, etc) can be further provided on the basis of ACL information. Moreover, separate security servers are not necessary, thereby advantageously achieving significantly simple system structure and session process.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a structure of a digital information storage system according to a first embodiment of the present invention;

FIG. 2 is a block diagram showing detailed structures of one of user terminals and a shared storage of FIG. 1;

FIG. 3 is a flowchart showing an operation of storing digital information in a digital information storage system of FIG. 2;

FIG. 4 is a flowchart showing an encryption process of digital information of FIG. 3;

FIG. 5 is a flowchart showing an operation of digital information storage system of FIG. 2;

FIG. 6 is a block diagram showing a structure of a digital information storage system according to a second embodiment of the present invention; and

FIG. 7 shows an example of an ACL information table managed by an ACL information management module of a master user terminal.

### BEST MODE FOR CARRYING OUT THE INVENTION

In order to accomplish the first aspect of the present invention, there is provided a digital information storage system comprising: a shared storage containing unique hardware information; and one or more user terminals interoperating with the shared storage through a network, encrypting digital information by using the hardware information of the shared storage and storing the encrypted digital information in the shared storage, and decoding the encrypted digital information by using the hardware information while loading the stored digital information.

In this case, the user terminals may encrypt the digital information by including access control logic (ACL) information on the digital information. That is, the user terminals encrypt the digital information by generating a random key while encrypting the digital information, generate an encryption header containing the ACL information and the random key, and thereafter encrypt the generated encryption header by using the hardware information.

In addition, while decoding the stored digital information, the user terminals may decode the encrypted encrypt header by using the hardware information of the shared storage, and decode the digital information by extracting the random key from the decoded encryption header. In this case, the user terminals may extract the ACL information while decoding, and may use the digital information according to a permission specified by the extracted ACL information.

In addition, any one of the user terminals may be designated to a master user terminal, and the master user terminal may set ACL information of another user terminal. In this case, the ACL information set by the master user terminal may be managed while being stored in the shared storage.

In addition, the hardware information of the shared storage may be a physical serial number of the shared storage, and the user terminals may use the physical serial number as an encryption key and/or a decoding key.

In order to accomplish the second aspect of the present invention, there is provided a digital information security system installed in a user terminal that can interoperate with an external shared storage through a network, and comprising: an application program; an interface module that extracts hardware information of the shared storage; an encryption module that uses the extracted hardware information to encrypt digital information created by the application program; and a control module that stores the encrypted digital information in the shared storage by using the interface module.

In addition, the digital information security system may further comprise: an ACL information management module that sets and manages ACL information contained in the digital information; and a decoding module that decodes the encrypted digital information stored in the shared storage by using the hardware information of the shared storage.

In this case, the encryption module may generate a random key, encrypt the digital information by using the generated random key, generate an encryption header containing ACL information set by the ACL information management module, and encrypt the encryption header by using the hardware information.

In addition, the decoding module may extract the random key and the ACL information by decoding an encrypted encryption header contained in the encrypted digital information by using the hardware information of the shared storage, and decode the digital information by using the random key.

In addition, the application program may use a function permitted on the basis of the extracted ACL information when the decoded digital information is provided.

In order to accomplish the third aspect of the present invention, there is provided a digital information storing method comprising steps of: extracting hardware information of a shared storage from the shared storage; encrypting digital information by using the extracted hardware information; and storing the encrypted digital information in the shared storage. In this case, in the step of encrypting, the digital information is encrypted by including ACL information contained in the digital information.

In addition, the step of encrypting may further comprise steps of: generating a random key; encrypting the digital information by using the generated random key; generating an encryption header containing the random key and the ACL information; and encrypting the generated encryption header by using the hardware information of the shared storage.

In order to accomplish the fourth aspect of the present invention, there is provided a digital information providing method comprising steps of: extracting hardware information of a shared storage from the shared storage; decoding encrypted digital information stored in the shared storage by using the extracted hardware information; extracting ACL information contained in the decoded digital information; and determining whether the digital information will be provided or not according to the extracted ACL information.

In addition, the step of decoding may further comprise steps of: decoding an encryption header contained in the encrypted digital information by using the extracted hardware information; extracting the ACL information and a random key used in the encryption from the decoded encryption header; and decoding the encrypted digital information by using the extracted random key. In addition, if the determination result shows that an assigned ACL permits access to the digital information, the decoded digital information may be provided according to a permission specified by the ACL information.

### Mode for the Invention

The present invention will now be described more fully with reference to the accompanying drawings, in which exemplary embodiments of the invention are shown, so that this disclosure will be thorough and complete, and will fully convey the concept of the invention to those skilled in the art. For clarity, specific technical terminologies will be used to describe the exemplary embodiments of the present invention. However, the present invention is not limited to a particularly chosen terminology. Thus, the technical terminologies include all equivalent technical synonyms for describing operations performed in a similar manner to achieve a similar purpose.

### First Embodiment

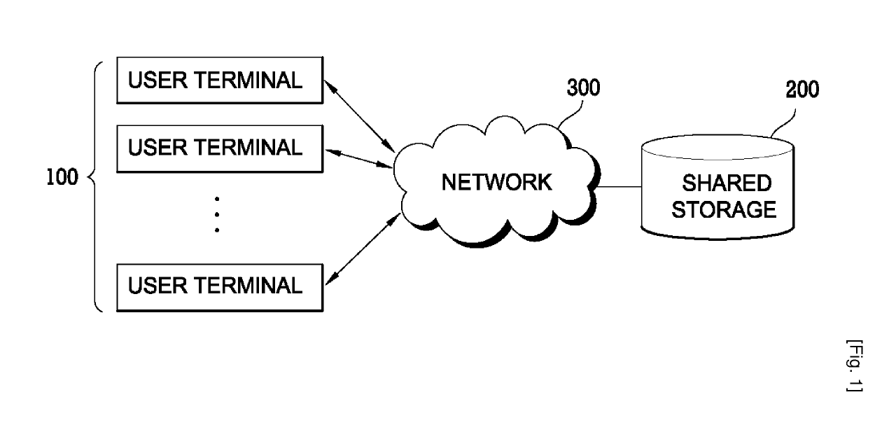

FIG. 1 is a block diagram showing a structure of a digital information storage system according to a first embodiment of the present invention.

Referring to FIG. 1, the digital information storage system includes a plurality of user terminals 100 and a shared storage 200.

The user terminals 100 can interchange data with the shared storage 200 through a network 300 according to a communication protocol. The network 300 may be a wire LAN (Local Area Network) or a wireless LAN suitable for a practical environment.

Each user terminal 100 includes a unique operation system (e.g. Windows, Unix, etc), and has to support a network connection. Examples of the user terminals 100 include a PC (Personal Computer), a mobile communication terminal, and a PDA (Personal Digital Assistant).

The shared storage 200 is an external storage medium that can interoperate with the network 300. Examples of the shared storage 200 include an external hard disk and an external memory card both of which has network chips.

In this case, the shared storage 200 may be connected to the user terminals 100 through a plug-and-play mechanism. That is, when the shared storage 200 is connected to the network 300, the connection of the shared storage 200 is detected by the operating system of the user terminal 100, and can be set in the form of a network drive. Accordingly, the shared storage 200 is recognized as a drive through an explorer. For example, the shared storage 200 may be shown through explorers of the user terminals 100 in the form of “D: drive” or “F: drive”.

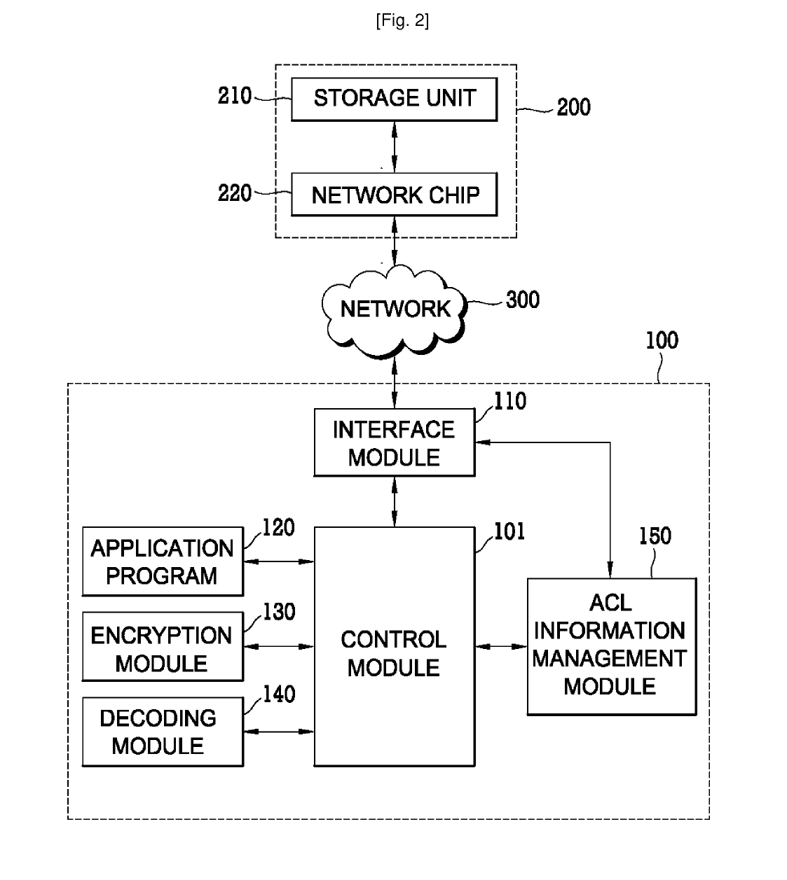

FIG. 2 is a block diagram showing detailed structures of one of the user terminals 100 of FIG. 1 and the shared storage 200 of FIG. 1.

Referring to FIG. 2, a user terminal 100 includes an interface module 110, an application program 120, an encryption module 130, a decoding module 140, an ACL information management module 150, and a control module 101.

The interface module 110 provides a network interface function so that the user terminal 100 can be connected to the shared storage 200 through the network 300. Preferably, the interface module 110 provides a plug-and-play function that automatically recognizes the connection of the shared storage 200.

The interface module 110 may extract hardware information of the shared storage 200 in response to the request of the control module 101. In this case, the hardware information may be a unique physical serial number assigned to the shared storage 200.

For example, as shown in FIG. 2, the shared storage 200 includes a storage unit 210 that stores digital information, and a network chip 220 that allows the storage unit 210 to interoperate with the network 300. A physical serial number indicating unique hardware information of the shared storage 200 is stored in the network chip 220.

In general, the physical serial number is formed in combination of alphanumeric characters, for example, “4C345G55-343B55F1”. This information cannot be identified by a user. Thus, an appropriate program is needed to extract the information. Accordingly, the physical serial number may be used as an encryption key in the process of encryption.

The application program 120 is defined as a program whereby digital information such as a electronic text or image can be created, stored, read, edited, and printed. Examples of the application program 120 include a word processor (e.g. MS-Word, Hun-min-jeong-eum, Hangul, etc) and an image editor (e.g. Photoshop, Auto CAD, etc).

Preferably, after digital information is completed, the application program 120 may store the digital information when a certain process of authentication is performed. The digital information stored in the shared storage 200 may be fetched so that the digital information can be read, edited, and printed according to a permission specified by ACL information contained in the digital information.

The ACL management module 150 performs a function for setting an ACL of the digital information to be stored in the shared storage 200, that is, the ACL information. In this case, the ACL is defined as a permission that enables reading, editing, and printing of the digital information. For example, if the user wants to deny other users editing and printing, ACL information may be set by the ACL management module 150 so that reading is allowed but editing and printing are denied. The user can easily set the ACL information through a GUI (Graphic User Interface) provided by the ACL management module 150.

The ACL information may be managed not only through the individual user terminal 100 but also a master user terminal assigned with a specific permission. This will be described below with reference to a second embodiment.

In response to an encryption request of the control module 101, the encryption module 130 encrypts the digital information to be stored in the shared storage 200 according to a specific algorithm. In this case, the encryption module 130 may be one of various commercial encryption algorithms. Examples of such algorithm include a Two-fish Encryption algorithm and a Blowfish Encryption algorithm.

Preferably, the encryption module 130 encrypts the digital information by using hardware information (e.g. physical serial number) of the shared storage 200 provided by the control module 101. During encryption, permission information contained in the digital information, that is, ACL information, may be inserted.

For example, the encryption module 130 generates a random key for encrypting the digital information. The digital information is then encrypted. An encryption header is generated in which ACL information that is set by the ACL management module 150 is inserted together with information on the generated random key. Thereafter, the generated encryption header is encrypted again by using the physical serial number of the shared storage 200 provided by the control module 101 as an encryption key.

The decoding module 140 decodes the encrypted digital information in response to a decoding request of the control module 101. Preferably, the decoding module 140 can perform decoding by using the hardware information of the shared storage 200 provided by the control module 101, that is, the physical serial number.

For example, the decoding module 140 decodes the encryption header by using the physical serial number of the shared storage 200 provided by the control module 101 as a decoding key. A random key contained in the decoded encryption header is then used to decode the digital information. In this case, the ACL information contained in the encryption header together with the random key is provided to the control module 101.

The control module 101 controls interactions of the aforementioned modules 110 to 150 as well as an overall data flow.

Preferably, the control module 101 provides a login function when connected to the shared storage 200. Thus, after connection is made, if the application program 120 requests the digital information to be stored, the control module 101 controls the interface module 120 so as to extract the hardware information of the shared storage 200. The extracted hardware information of the shared storage 220 is provided to the encryption module 130. Further, the control module 101 may provide the ACL information set by the ACL information management module 150 to the encryption module 130.

When a request to load the digital information stored in the shared storage 200 is received from the application program (120), the control module 101 controls the interface module 110, thereby extracting the hardware information of the shared storage 200. Then, the control module 101 provides the extracted hardware information of the shared storage 200 to the decoding module 140.

The shared storage 200 includes the network chip 220 and the storage unit 210.

The network chip 220 performs an interface function so that the shared storage 200 can interoperate with the external network 300. Further, the network chip 220 stores the hardware information of the shared storage 200, for example, a physical serial number. The hardware information may be extracted through the user terminal 100.

The storage unit 210 serves to store digital information. The storage unit 210 may include a plurality of folders to store the digital information.

The digital information storage system according to the first embodiment of the present invention does not require a separate security server at the time of system implementation. Further, the access to the shared storage 200 can be achieved conveniently in the form of a network drive. Since the physical serial number that is the hardware information contained in the shared storage 200 is used as an encryption key, even if the digital information is illegally stored in another storage medium, reproduction thereof is not possible. Accordingly, information leakage can be prevented.

These advantages will become more apparent through the following descriptions on the operation of the digital information storage system.

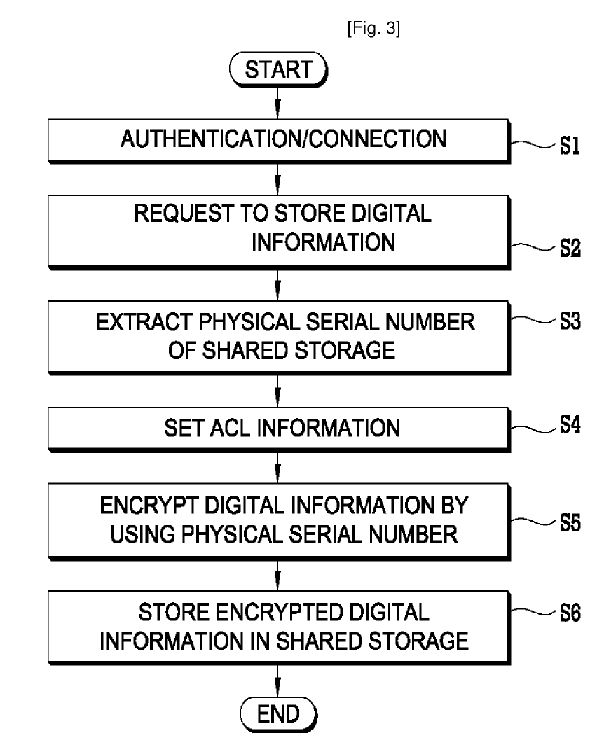

FIG. 3 is a flowchart showing the operation of storing digital information in the digital information storage system of FIG. 2.

Referring to FIGS. 2 and 3, in order for the user terminal 100 to store data in the shared storage 200, an initial authentication process is required. That is, even if the shared storage 200 is set as a network drive in the user terminal 100, in order to access the shared storage 200, a specific authentication method is carried out before connection is made (step S1).

The authentication method may be a commercial authentication method for accessing a network derive. For example, an authentication method using a user ID and a password may be used. Such authentication may be carried out when there is a request from a user, or in the process of booting the user terminal 100, or when the digital information is initially stored after booting.

Once the authentication and connection are completed, the user executes the application program 120 of the user terminal 100, and generates desired digital information. Thereafter, the user requests the digital information to be stored in the shared storage 200 (step S2). The generated digital information may be a text file newly created by the user, a non-encrypted text file fetched from another storage medium, or a text file updated after being fetched from the storage medium.

When it is requested to store the digital information by the user, the user terminal 100 extracts the hardware information of the shared storage 200, that is, a physical serial number, from the shared storage 200 (step S3).

The extraction process (step S3) may be carried out under the control of the control module 101 of the user terminal 100. That is, when the request of storing the digital information is received from the application program 120, the control module 101 instructs the interface module 110 to extract the physical serial number of the shared storage 200. In response to the instruction, the interface module 110 scans information stored in the network chip 220, extracts the physical serial number, and thereafter transmits it to the control module 101.

Subsequently, the user terminal 100 sets ACL information for the digital information formation (step S4). This may be performed by the ACL information management module 150. That is, the ACL information management module 150 may set the ACL information by receiving the ACL information from the user. Thus, according to the setting of the ACL information, the user may not allow other users to edit and print the digital information.

The ACL may be discriminately restricted according to users. That is, it is possible to set only reading and printing of the digital information to a user terminal, and set only reading and editing of the digital information to another terminal.

The ACL information input through the process of inputting ACL information (step S4) may be provided to the encryption module 130 under the control of the control module 101. In the process of setting ACL information (step S4), the ACL information may be automatically set on the basis of default information even if the user does not additionally input the ACL information. The default information may be set such that all users can have a specific ACL, or each user terminal has a different ACL.

Thereafter, the user terminal 100 encrypts the digital information by using the physical serial number (step S5). The encrypted digital information may include ACL information. The encryption process (step S5) may be performed by the encryption module 130 of the user terminal 100 as described below.

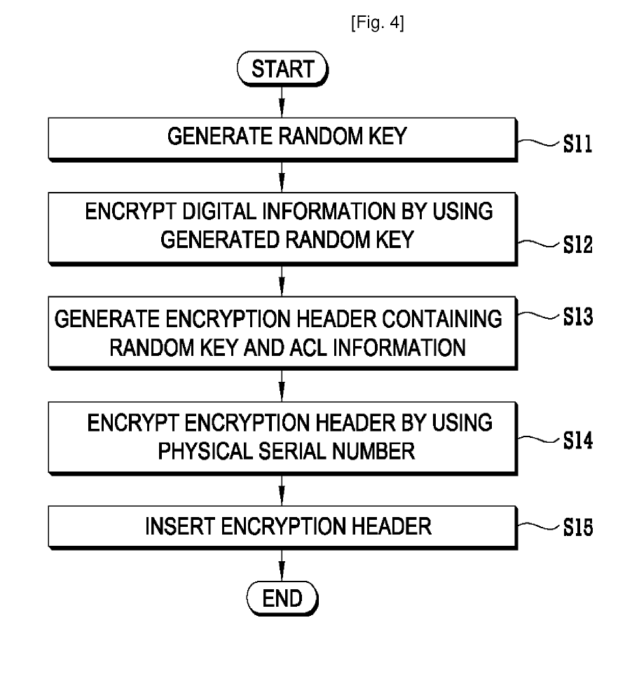

FIG. 4 is a flowchart showing the encryption process of digital information (step S5) of FIG. 3.

Referring to FIG. 4, the encryption module 130 generates a random key for encrypting digital information (step S11), encrypts the digital information (step S12), generates an encryption header by using the random key and ACL information provided from the control module 101 (step S13), encrypts the encryption header by using a physical serial number provided from the control module 101 (step S14), and inserts the encryption header (step S15). Therefore, finally encrypted digital information has an encryption header which has been encrypted by using a physical serial number.

After the encryption process (step S5) is completed, the user terminal 100 stores the finally encrypted digital information in a desired folder of the shared storage (step S6). Accordingly, encrypted digital information is stored in the shared storage 200.

These processes (steps S1 to s5) are performed in a plurality of user terminals 100. Hence, digital information stored in the user terminals 100 is stored in the shared storage 200. The stored digital information may be provided to the user terminals 100 on the basis of the following operation of providing digital information.

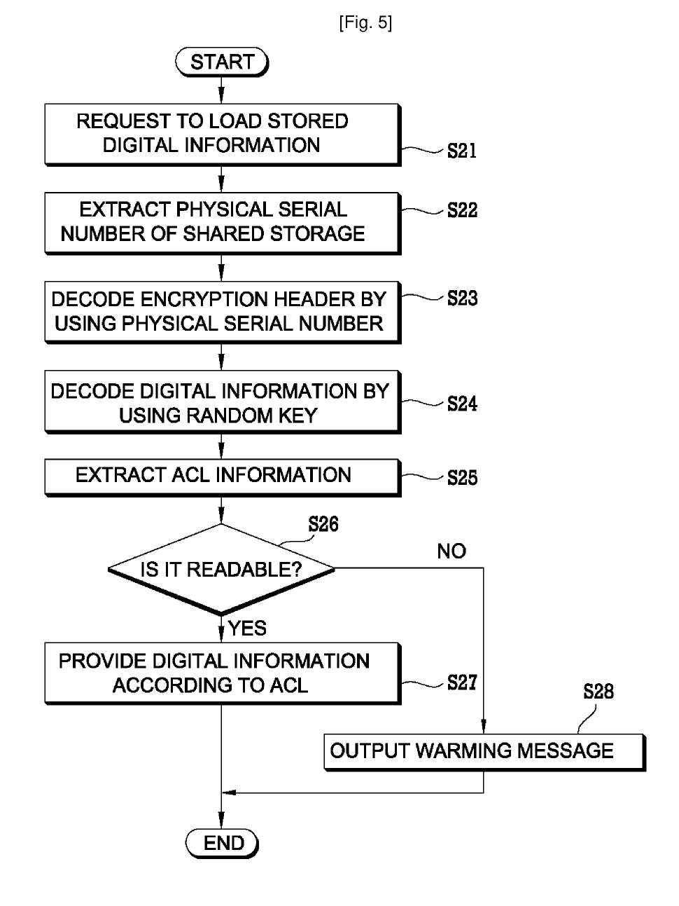

FIG. 5 is a flowchart showing the operation of digital information storage system of FIG. 2.

Referring to FIG. 5, in a state that a user terminal 100 is connected to the shared storage 200 through authentication, a user uses the application program 120 to request the loading of specific digital information stored in the shared storage 200 (step S21). Then, hardware information of the shared storage 200, that is, a physical serial number, is extracted from the shared storage 200 (step S22).

The process of extracting physical serial number (step S22) may be performed by the interface module 110 under the control of the control module 101. That is, the control module 101 instructs the interface module 110 to extract the physical serial number. In response to the instruction, the interface module 110 scans information stored in the network chip 220, extracts the physical serial number, and thereafter transmits it to the control module 101.

Subsequently, the user terminal 100 fetches the encrypted digital information stored in the shared storage 200, and decodes an encryption header of the encrypted digital information by using the extracted physical serial number (step S23).

The process of decoding encryption header (step S23) may be performed by the decoding module 140. That is, the decoding module 140 decodes an encryption header of the encrypted digital information by using the physical serial number provided from the control module 101 as a decoding key.

If the encrypted digital information is loaded by another storage medium instead of the shared storage 200 due to an illegal copy or the like, the physical serial number of the storage medium may be different from the physical serial number of the shared storage 200. Hence, there is no way to decode the encryption header. Accordingly, an illegal copy or an abnormal usage can be prevented.

After the process of decoding encryption header (step S23) is performed, the user terminal 100 extracts a random key included in the decoded encryption header, and decodes digital information (step S24).

The process of decoding digital information (step S24) may be performed by the decoding module 140. That is, the decoding module 140 extracts the random key included in the encryption header, and decodes the digital information by using the extracted random key as a decoding key.

Subsequently, the user terminal 100 extracts ACL information of the user terminal 100 included in the encryption header (step S25), and analyses the extracted ACL information so as to determine whether the user terminal 100 has an ACL that permits the reading of the digital information (step S26).

If the user terminal 100 has an ACL that denies the reading of the digital information, a warming message or the like is output instead of loading the digital information (step S28). For example, the warming message may be You have no permission to read the file. This may be performed by the control module 101.

On the other hand, if the determination result shows that the user terminal 100 has an ACL to read the digital information, the decoded digital information is provided according to a permission specified by the ACL through the application program 120 (step S27).

For example, if the user terminal 100 has an ACL that permits editing, the function of the application program 120 is activated to enable editing and storing of digital information. If the user terminal 100 has an ACL that denies editing, the update of the digital information is denied, and a warming message or the like is output. For example, the warming message may be “You have no permission to edit the file.”

If the user terminal 100 has a print ACL, a printing function of the application program 120 is activated. In the case of having an ACL to deny printing, the printing function is denied, and a warming message or the like is output. For example, the warning message may be “You have no permission to print.”

Therefore, according to the ACL information contained in the encrypted digital information, the user can be provided with digital information according to a permission given to the user.

So far, a technique has been described according to the first embodiment, in which encryption and decoding are performed by using hardware information of the shared storage 20, thereby enhancing security and simplifying a system structure.

In addition, according to the first embodiment, the user can directly set the ACL information when the digital information is stored. Thus, an ACL can be restricted through encryption and decoding. However, in some practical environments, the ACL information may be managed by assigning a portion of storage area of the shared storage 200, thereby managing ACL. This will be described according to a second embodiment of the present invention.

### Second Embodiment

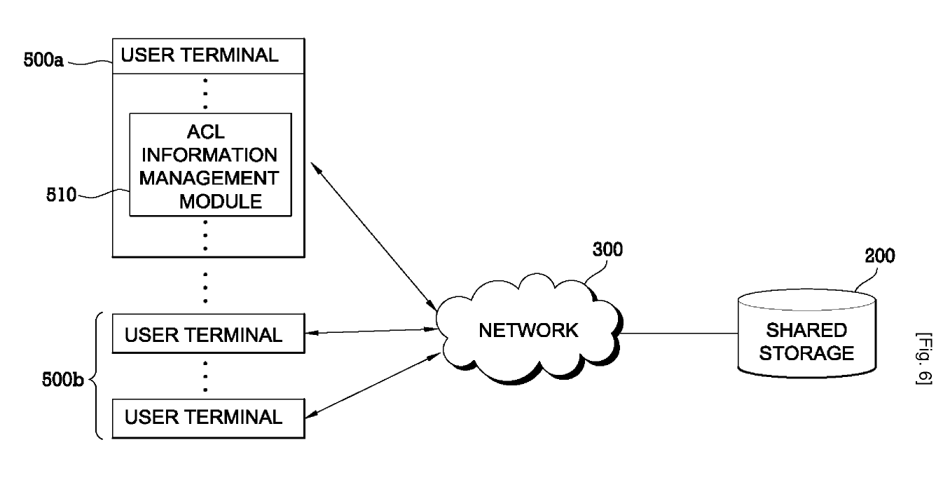

FIG. 6 is a block diagram showing a structure of a digital information storage system according to a second embodiment of the present invention.

Referring to FIG. 6, the digital information storage system includes a plurality of user terminals 500a and 500b, and a shared storage 200.

One of the user terminals 500a and 500b may be designated as a master user terminal 500a. The master user terminal 500a may set and manage not only its own ACL information but also ACL information of other user terminals 500b in conjunction with the shared storage 200. Therefore, the master user terminal 500a may be designated as a user terminal for an administrator or manager of an enterprise.

The master user terminal 500a and the rest of user terminals 500b include modules having the same structure as those of the aforementioned user terminal 100 of FIG. 2. In the case of the user terminal 500a, however, a few functions of an ACL information management module thereof is added. That is, an ACL information management module 510 of the master user terminal 500a additionally has a function for setting an ACL of digital information stored in the shared storage 200.

In this case, the ACL information is set by the ACL information management module 510 of the master user terminal 500a, and is managed while being separately stored in the shared storage 200. Preferably, the ACL information stored in the shared storage 200 may be set on the basis of folders, files, and users. Further, the ACL information may be managed in the form of a table.

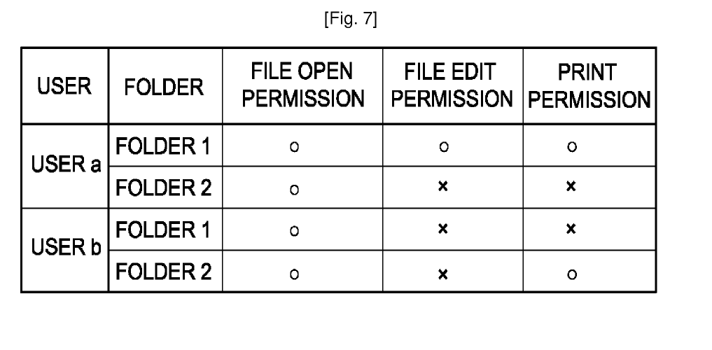

FIG. 7 shows an example of an ACL information table managed in the shared storage 200 by the ACL information management module 510 of the master user terminal 500a. Herein, ACL information is managed on the basis of folders.

Referring to FIG. 7, “File open ACL”, “File edit ACL”, and “Print ACL” are respectively assigned to folders according to users.

For example, for a “User a”, file opening, editing, and printing are all allowed in a “Folder 1”, and only file opening is allowed in a “Folder 2”. In addition, for a “User b”, only file opening is allowed in the “Folder 1” and only file opening and printing are allowed in the “Folder 2”.

With this ACL setting, usage of each folder can be restricted according to users. Although a folder-based ACL setting has been shown in FIG. 7, the ACL information may be managed in various manners, as described above, such as, on the based of files and users.

In order to apply the ACL information stored in the shared storage 200 to pre-stored encrypted digital information, the ACL information management module 510 of the master user terminal 500a decodes an encryption header contained in the pre-stored encrypted digital information by using the physical serial number of the shared storage 200. ACL information existing in the decoded encryption header is updated into the ACL information set by the master user terminal 500a, and is then encrypted again by using the physical serial number.

Thus, when the user terminals 500a and 500b fetch the digital information stored in the shared, ACLs are assigned according to the updated ACL information.

In another method of applying the set ACL information to the shared storage 200, instead of updating the aforementioned ACL information, the set ACL information may be applied on the basis of login information (ID and password) authorized in advance while the user terminals 500a and 500b load digital information. The master user terminal 500a may assign a user-based ACL and a folder-based ACL to the shared storage 200.

In this case, the ACL information assigned by the user terminals 500a and 500b, in which digital information has been stored, may have a different ACL from the ACL information stored in the shared storage 200. That is, an ACL assigned by a user who stores the digital information may be different from an ACL assigned by an administrator. For ACL restriction, in this case, priority may be determined between the ACL information assigned by the user terminals 500a and 500b and the ACL information stored in the shared storage 200 by the master user terminal 500a. The priority may be determined in advance by the control module of the user terminals 500a and 500b.

For example, when ACL information is extracted while decoding digital information, the ACL information is compared with ACL information stored in the shared storage 200, and hence ACL information having a high priority is applied. Preferably, the priority is determined so that a strict ACL has a higher priority.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

According to the present invention, digital information is encrypted by using hardware information of a shared storage. The digital information can be thus protected against leakage caused by an illegal copy or the like. In addition, the shared storage for storing the digital information is connected to a user terminal in the form of a network drive, thereby improving convenience in use. Various functions (e.g. editing, printing, etc) can be further provided on the basis of ACL information. Moreover, separate security servers are not necessary, thereby advantageously achieving significantly simple system structure and session process.

1. A digital information storage system comprising:
a shared storage containing unique hardware information; and
one or more user terminals interoperating with the shared storage through a network, encrypting digital information by using the hardware information of the shared storage and storing the encrypted digital information in the shared storage, and decoding the encrypted digital information by using the hardware information while loading the stored digital information.

2. The digital information storage system of claim 1, wherein the user terminals encrypt the digital information by including access control logic (ACL) information on the digital information.

3. The digital information storage system of claim 2, wherein the user terminals encrypt the digital information by generating a random key while encrypting the digital information, generate an encryption header containing the ACL information and the random key, and thereafter encrypt the generated encryption header by using the hardware information.

4. The digital information storage system of claim 3, wherein, while decoding the stored digital information, the user terminals decode the encrypted encrypt header by using the hardware information of the shared storage, and decode the digital information by extracting the random key from the decoded encryption header.

5. The digital information storage system of claim 2, wherein the user terminals extract the ACL information while decoding, and can use the digital information according to a permission specified by the extracted ACL information.

6. The digital information storage system of claim 1, wherein any one of the user terminals is designated to a master user terminal, and the master user terminal can set ACL information of another user terminal.

7. The digital information storage system of claim 6, wherein the ACL information set by the master user terminal is managed while being stored in the shared storage.

8. The digital information storage system of claim 7, wherein the master user terminal updates ACL information contained in the encrypted digital information stored in the shared storage into the ACL information set by the master user terminal.

9. The digital information storage system of claim 1, wherein the hardware information of the shared storage is a physical serial number of the shared storage, and the user terminals use the physical serial number as an encryption key and/or a decoding key.

10. A digital information security system installed in a user terminal that can interoperate with an external shared storage through a network, and comprising:
an application program;
an interface module that extracts hardware information of the shared storage;
an encryption module that uses the extracted hardware information to encrypt digital information created by the application program; and
a control module that stores the encrypted digital information in the shared storage by using the interface module.

11. The digital information security system of claim 10, further comprising:
an ACL information management module that sets and manages ACL information contained in the digital information; and
a decoding module that decodes the encrypted digital information stored in the shared storage by using the hardware information of the shared storage.

12. The digital information security system of claim 11, wherein the encryption module generates a random key, encrypts the digital information by using the generated random key, generates an encryption header containing ACL information set by the ACL information management module, and encrypts the encryption header by using the hardware information.

13. The digital information security system of claim 12, wherein the decoding module extracts the random key and the ACL information by decoding an encrypted encryption header contained in the encrypted digital information by using the hardware information of the shared storage, and decodes the digital information by using the random key.

14. The digital information security system of claim 13, wherein the application program can use a function permitted on the basis of the extracted ACL information when the decoded digital information is provided.

15. A digital information storing method comprising steps of:
extracting hardware information of a shared storage from the shared storage;
encrypting digital information by using the extracted hardware information; and
storing the encrypted digital information in the shared storage.

16. The digital information storing method of claim 15, wherein, in the step of encrypting, the digital information is encrypted by including ACL information contained in the digital information.

17. The digital information storing method of claim 16, wherein the step of encrypting further comprises steps of:
generating a random key;
encrypting the digital information by using the generated random key;
generating an encryption header containing the random key and the ACL information; and
encrypting the generated encryption header by using the hardware information of the shared storage.

18. A digital information providing method comprising steps of:
extracting hardware information of a shared storage from the shared storage;
decoding encrypted digital information stored in the shared storage by using the extracted hardware information;
extracting ACL information contained in the decoded digital information; and
determining whether the digital information will be provided or not according to the extracted ACL information.

19. The digital information providing method of claim 18, wherein the step of decoding further comprises steps of:
decoding an encryption header contained in the encrypted digital information by using the extracted hardware information;
extracting the ACL information and a random key used in the encryption from the decoded encryption header; and
decoding the encrypted digital information by using the extracted random key.

20. The digital information providing method of claim 18, wherein, if the determination result shows that an assigned ACL permits access to the digital information, the decoded digital information is provided according to a permission specified by the ACL information.
